(19) United States
(12) Patent Application Publication
(10) Pub. No.: US 2015/0269655 A1
(43) Pub. Date: Sep. 24, 2015

(54) TRAILER NOTIFICATIONS

(71) Applicant: Apple Inc., Cupertino, CA (US)

(72) Inventors: Sam Gharabally, San Francisco, CA (US); Keith Paul Kowalczykowski, San Jose, CA (US); Sam Vafaee, Palo Alto, CA (US)

(21) Appl. No.: 14/458,149

(22) Filed: Aug. 12, 2014

Related U.S. Application Data
(60) Provisional application No. 61/969,738, filed on Mar. 24, 2014.

(51) Int. Cl. G06Q 30/06

(52) U.S. Cl. CPC G06Q 30/0639

(57) ABSTRACT

The subject disclosure relates to a method for providing user notifications related to the release of a movie or other media item. In some implementations, the method includes steps for receiving an interest signal for a user, the interest signal comprising a selection of one or more media items for which the user has indicated an interest; receiving a locations signal, the locations signal comprising location information corresponding with one or more of the user's preferred theatre locations, and searching, a media database to determine if any of the one or more media items is available to the user, wherein searching the media database is performed using the interest signal and the locations signal. Systems and computer readable media are also provided.

### CROSS-REFERENCE TO RELATED APPLICATION

This application claims priority to U.S. Provisional Application 61/969,738, filed Mar. 24, 2014, the complete disclosure of which is incorporated herein by reference in its entirety.

### BACKGROUND

1. Technical Field

The subject technology relates to methods and systems for providing consumer notifications regarding newly released media items, and in particular notifications regarding the new availability at a theatre or location of the consumer's preference.

2. Introduction

New media items are often advertised using trailers or billboards, for example, to inform potential consumers of an upcoming release date. However, such advertisements do not provide indications as to where a respective media item, such as a film, will be available upon release. Additionally, conventional advertisements to not provide a convenient way to track release dates or provide reminders once a title of interest becomes available.

### SUMMARY

In certain aspects, the disclosed subject matter relates to a computer-implemented method for providing user notifications, the method including steps for receiving, at a mobile electronic device, an interest signal for a user associated with the mobile electronic device, the interest signal comprising a selection of one or more media items for which the user has indicated an interest, receiving, at the mobile electronic device, a locations signal, the locations signal comprising location information corresponding with one or more of the user's preferred theatre locations, and searching, by the mobile electronic device, a media database to determine if any of the one or more media items is available to the user, wherein searching the media database is performed using the interest signal and the locations signal.

In another aspect, the disclosed subject matter relates to a mobile computing device, including, a display, one or more processors communicatively coupled to the display, and a computer-readable medium comprising instructions stored therein, which when executed by the processors, cause the processors to perform operations including, receiving, at a mobile electronic device, an interest signal for a user associated with the mobile electronic device, the interest signal comprising a selection of one or more media items for which the user has indicated an interest, receiving, at the mobile electronic device, a locations signal, the locations signal comprising location information corresponding with one or more of the user's preferred theatre locations, searching, by the mobile electronic device, a media database to determine if any of the one or more media items is available to the user, wherein searching the media database is performed using the interest signal and the locations signal.

In yet another aspect, the disclosed subject matter relates to a computer-readable medium comprising instructions stored therein, which when executed by a processor, cause the processor to perform operations comprising: receiving, at a mobile electronic device, an interest signal for a user associated with the mobile electronic device, the interest signal comprising a selection of one or more media items for which the user has indicated an interest, receiving, at the mobile electronic device, a locations signal, the locations signal comprising location information corresponding with one or more of the user's preferred theatre locations, and searching, by the mobile electronic device, a media database to determine if any of the one or more media items is available to the user, wherein searching the media database is performed using the interest signal and the locations signal.

It is understood that other configurations of the subject technology will become readily apparent to those skilled in the art from the following detailed description, wherein various configurations of the subject technology are shown and described by way of illustration. The subject technology is capable of other and different configurations and its several details are capable of modification in various respects without departing from the scope of the subject technology. Accordingly, the detailed description and drawings are to be regarded as illustrative and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a flow diagram of an example method for providing item notifications to a user, according to some aspects of the subject technology.

FIG. 2 illustrates an example of a display for providing item notifications to a user, according to some aspects of the technology.

FIG. 3 illustrates another example of a display for providing item notifications to a user, according to some aspects of the technology.

FIG. 4 illustrates an example of a network system for implementing notification methods of the subject technology.

FIG. 5 illustrates an example electronic system with which some aspects of the technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

The subject technology addresses the foregoing limitations of conventional media advertisements by providing a way to notify or remind consumers when a media item, such as a film, is available for viewing in theatre or is available for download. Aspects of the technology also provide methods for delivering notifications or reminders that are location based, for example, on a geographic location of the consumer and/or the consumer's theatre preferences. As explained in further detail below, some implementations of the technology can also provide consumer indications that facilitate the consumer's ability to purchase (or rent) access to a media item, via an online store or media player interface, such as Apple's iTunes.

Methods of the subject technology can be implemented using application software that resides on a mobile device, such as a smart phone or mobile computing device. In certain aspects, a user/consumer can indicate interest preferences (e.g., an interest signal), on the mobile device, in order to indicate a media item that the user has an interest in viewing or purchasing. Indications of a user's interest preferences can be generated in different ways, depending on implementation. For example, a user may explicitly indicate media items that he/she is interested in; alternatively, the user's viewing habits or past purchase history may be used to infer media items for which the user may have an interest. Upon a detected availability of the item of interest, for example, the availability of a film for viewing in theatre (or availability for download), the user is notified of the items' availability using the mobile device.

In certain aspects, notifications provided to the user can contain additional information, such as metadata or links to enable the user to browse to a location where he/she can learn more information about the media item, purchase the item, or purchase item related goods or services.

By way of example, a user may be interested in watching an upcoming film once the film is available in theatres. As such, the user can indicate his/her preference, for example, in a watch list or favorites list on his/her mobile device, such as a smart phone. In some implementations, the user may also provide an indication of his/her preferred theatres for watching new movies or films (e.g. a locations preference). Using the user's movie interest information, as well as the user's locations preference, the mobile device can periodically search for a status of the film of interest. Once the film becomes available, for example in theatres, information about the availability is pulled from a remote database and used to formulate a notification can be provided to the user, e.g., that the film can be viewed at a location/theatre that matches the user's preference.

As discussed in further detail below, display of a notification regarding item availability may be subject to one or more additional rules, such as based on a current location of the user, or based on a determination that the current time is within a predetermined time window for which notifications can be delivered.

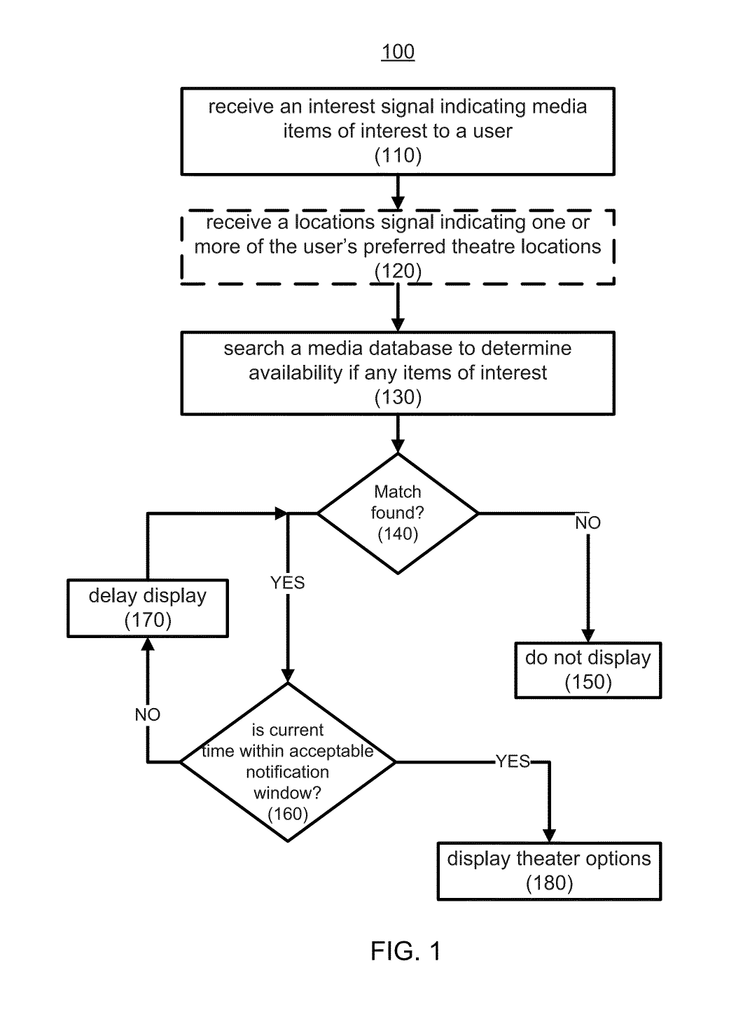

FIG. 1 illustrates a flow diagram of an example method 100 for providing item notifications to a user. Method 100 begins with step 100 in which an interest signal is received (e.g., by a processor based device or mobile device) of the user. The interest signal contains information regarding one or more media items that are of interest to the user. It is understood that the processor based device may include various types of personal computing devices, or mobile computing devices, such as a smartphone or tablet computer. Additionally it is understood that the interest signal may include (or be generated from) any type of information that indicates the user's preferences for digital content. Furthermore, the subject media items can include various forms of media including, but not limited to, film/s, music, television programming, and/or computer games.

In practice, the user's interest signal can be generated by explicit actions taken by the user, such as marking, “liking” or indicating particular items as being of user interest. By way of example, the user may generate a list, such as a watch list or favorites list that is used to generate the interest signal.

Once the interest signal has been received, method 100 proceeds to (optional) step 120 in which a locations signal is received, indicating the user's preference for one or more locations at which the media items are to be viewed or purchased. Similar to the interest signal, the location signal may be based on explicit user selections. By way of example, the user locations signal can include one or more of: indications of specific theatre locations, retail store locations, names of theatre chains or the name of an operating company, and/or one or more preferred geographic areas in which the user would prefer to visit a theatre.

In step 103, a media database is searched to determine availability of any items matching those that correspond with the user's interest signal. By way of example, if the user indicated a desire to watch the movie Dune, the media database may be searched to determine if any movie with the title “Dune” was yet available in theatres. In a further example, the user's interest signal comprises an indication that the user is interested in any film by the director Stanly Kubrick, then the media database may be similarly searched with that criteria. It is understood that the user's interest signal may include a variety of criteria related to the user's preferences, including but not limited to: film title/s, genre/s, Motion Picture Associate of America (MPAA) rating categories, director/s, producer/s, actor name/s, and/or studio/s, etc.

Subsequently, in step 140 it is determined whether or not a match was found for the search in the media database of step 130. If a no match was found (indicating that no items were found to match the user's interest criteria), method 100 proceeds to step 150 in which no options are provided/displayed to the user. Alternatively, if in step 140 it is determined that one or more items was identified in the media database, then method 100 proceeds to step 160, in which it is determined if the current time is within an acceptable notification window.

In practice, it can be more helpful to provide the user with notifications during times of the day when the user is most likely to pay attention to the notification. Additionally, there may be times in which it may be undesirable for the user to receive notifications, such as late in the night. Accordingly, notifications may only be delivered to the user during a predetermined time window, such as from 9AM to 9PM in the user's local time. It is understood that the notification time window can be predetermined, based on user use data, or configurable by the user.

If in step, 160 it is determined that the current time is outside of the acceptable delivery window, then process 100 proceeds to step 170, in which the user notification is delayed before the determination of step 160 is revisited. Alternatively, if in step 160 it is determined that the current time is within an acceptable delivery window, then process 100 proceeds to step 180, in which one or more item notifications are delivered to the user.

The delivery of notifications can be performed in various manners, depending on implementation. By way of example, the user may be provided with visual, audible, or haptic notifications to draw his/her attention to the device on which information for the media items is displayed.

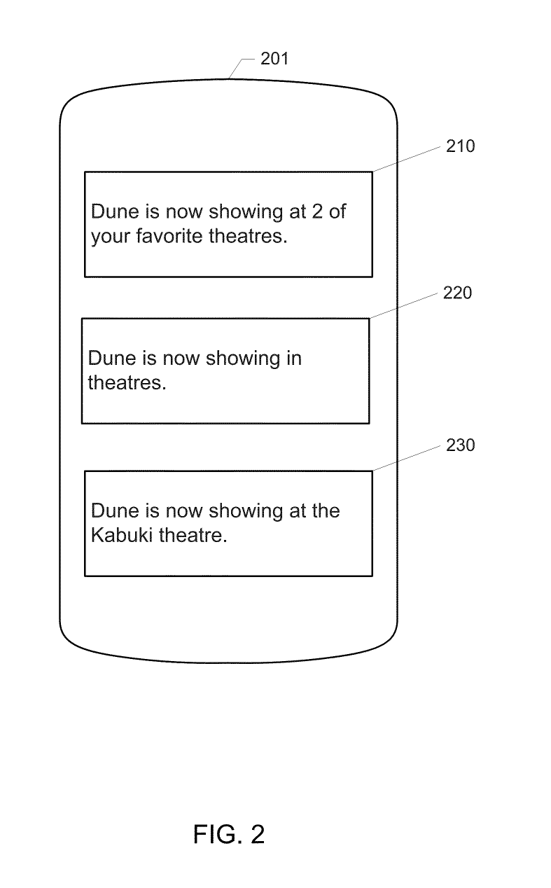

FIG. 2 illustrates an example display 201 for providing film viewing options to a user, according to some aspects of the technology. As illustrated by display 201, notifications can be provided to the user in various matters, including providing an indication of a number theatres in which an interest item can be viewed (consistent with notification 210), providing an indication that an interest item is generally available in theaters (consistent with notification 220), and/or providing a notification that the interest item is showing at a particular theatre that is consistent with an indicated preference of the user (consistent with notification 230).

Notifications that are specific to a particular location or theatre (such as notification 230), can be generated based on the user's locations signal, indicating one or more preferred viewing theatre/s of the user. Additionally, delivery of the notification and/or indications of theatre availability can be based on a current location of the user, for example, determined using Global Positioning System (GPS) location data of the user's mobile device (e.g., smart phone or tablet device). Thus, item notification/s can be provided at a time when it is determined that the user is in a location proximate a preferred theater.

Further to the example of FIG. 2, if a user indicated an interest in viewing an upcoming release of the film Dune, and at the same time indicated (e.g., in a favorites list), that the Kabuki theatre in San Francisco is a preferred viewing location, then this information is used to perform a media database search (e.g., as described above with respect to step 130). Upon searching the media database, to determine the current release status of Dune, and upon identifying that Dune is available within a particular time window (e.g., for viewing in theaters within the next two days), notification 230 is provided to the user. As discussed above, notification 230 can be delivered based on the user's location information, as well as a current time. For example, notification 230 may be provided to the user when the user is in a geographic location proximate to the Kabuki theatre, but not outside a predetermined window of time in which the user is likely to immediately receive the notification (e.g., the notification is not delivered at 2:00AM).

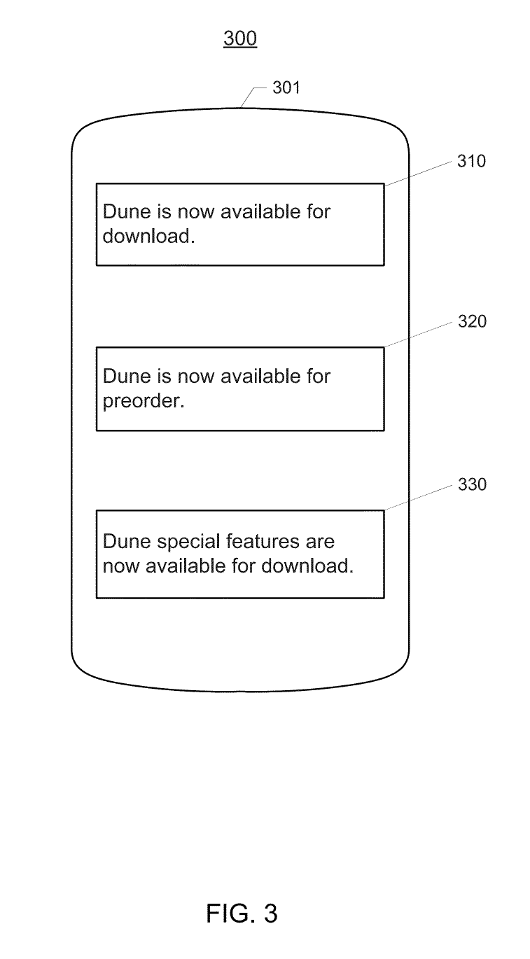

FIG. 3 illustrates yet another example of a display 301 in which item notifications can be provided to a user. As illustrated, display 301 provides example notifications that indicate information regarding the availability of a content item for download (consistent with notification 310), notifications that indicate the availability of an item for pre-sale or pre-order (consistent with notification 320), and/or notifications indicating the availability of item related content, such as special features or behind the scenes programming (consistent with notification 330).

It is understood that in other implementations, a greater or fewer number of notifications may be provided. Additionally, provided notifications can contain other additional (or less) information than that illustrated in FIGS. 2 and 3. For example, an item notification may include metadata, hyperlinks or purchase options to enable the user to acquire additional information about an item, or to purchase an item.

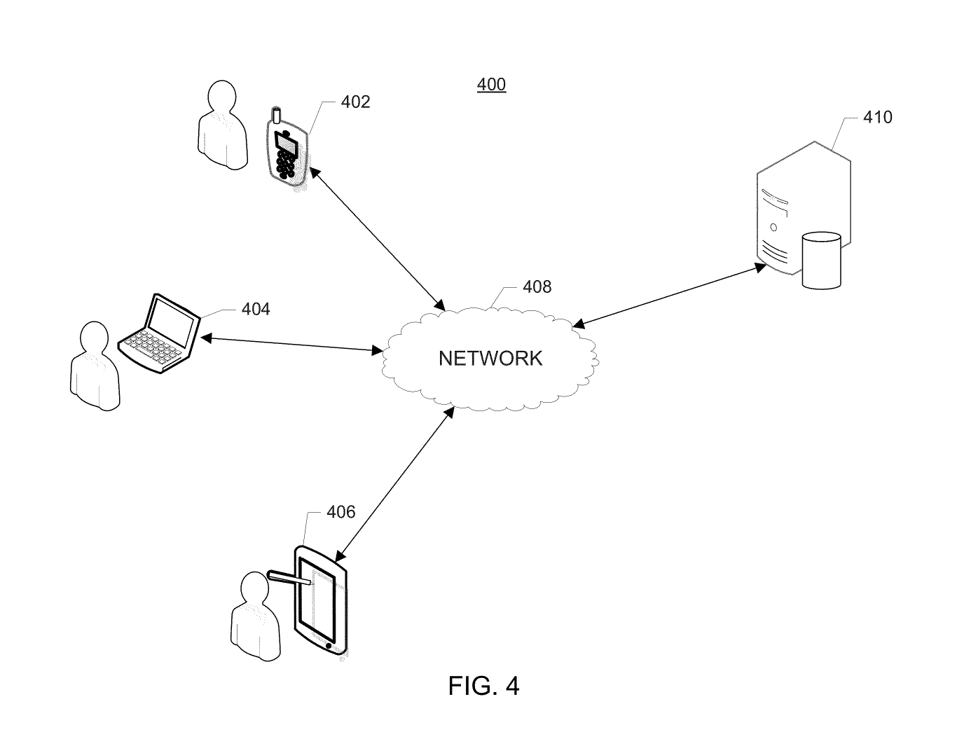

FIG. 4 conceptually illustrates an example network system for implementing some aspects of the subject disclosure. Specifically, network system 400 comprises first user device 402, second user device 404, third user device 406, network 408 and server 410. User devices 402-404 can include any processor based electronic device on which methods of the foregoing technology may be implemented to facilitate the delivery of item notifications. By way of example, first user device 402 can be a smart phone, second user device 404 can be a personal computer (PC), and third user device 406 can be a tablet computer device.

First user device 402, second user device 404, third user device 406 and server 410 are communicatively connected via the network 408. It is understood that in addition to first user device 402, second user device 404, third user device 406 and server 410, any number of other processor-based devices could be communicatively connected to network 408. Furthermore, as will be discussed in greater detail below, network 408 could comprise multiple networks, such as a network of networks, e.g., the Internet.

In certain aspects, a processor-based device, or mobile device, as discussed above, can correspond with any of user devices 402-406. By way of example, first user device 402 can be a mobile phone or smart phone device for implementing methods of the subject technology, and to facilitate the delivery of item notifications to an associated user. Additionally, in some implementations, a media database may be maintained at a remote storage location, including one or more computers or servers, such as server 410, communicatively coupled to user devices 402-406 via a network, such as network 408.

Server 410 can be used to host, a media database that is searched for available content items that may be of interest to a respective user. For example, if a user associated with first user device 402 is interested in watching an upcoming release of Dune, first user device may pull information regarding the Dune film from server 410, across network 408, and onto first user device 402 for display to the user.

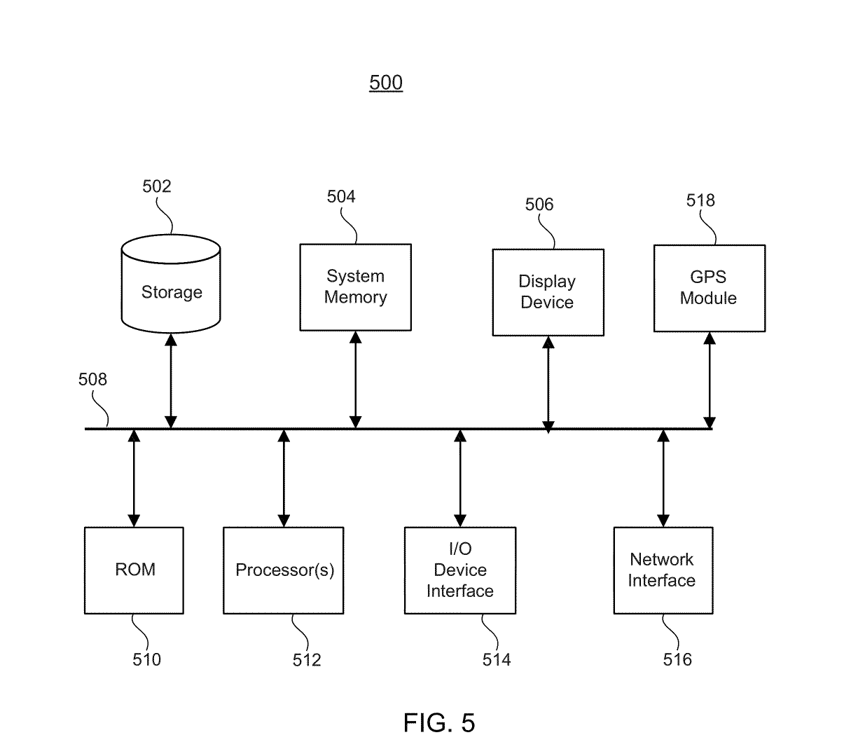

FIG. 5 illustrates an example of an electronic system 500. Electronic system 500 can be a computer, smart-phone, PDA, tablet computing device, or any other processor-based electronic device. System 500 includes storage 502, system memory 504, display device 506, ROM 510, processor/s 512, I/O device interface 514, network interface 516, and GPS module 518. Each of the forgoing hardware modules are coupled via bus 508, which collectively represents all system, peripheral, and chipset buses that communicatively connect the numerous internal devices of electronic system 500.

From these various memory units, processing unit(s) 512 retrieves instructions to execute and data to process in order to execute the processes of the subject disclosure. The processing unit(s) can be a single processor or a multi-core processor in different implementations. ROM 510 stores static data and instructions that are needed by processing unit(s) 512 and other modules of the electronic system. Storage device 502, on the other hand, is a read-and-write memory device. This device is a non-volatile memory unit that stores instructions and data even when electronic system 500 is off. Some implementations of the subject disclosure use a mass-storage device (such as a flash storage memory) as storage device 502. Like storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, storage device 502, and/or ROM 510.

The various memory units can include instructions for receiving an interest signal for a user associated with the mobile electronic device, the interest signal comprising a selection of one or more media items for which the user has indicated an interest; receiving, a locations signal, the locations signal comprising location information corresponding with one or more of the user's preferred theatre locations, and searching, by the mobile electronic device, a media database to determine if any of the one or more media items is available to the user, wherein searching the media database is performed using the interest signal and the locations signal.

Bus 508 also connects processor/s 512 to I/O interface 514, which enables the user to communicate information and select commands to the electronic system. Input devices used with electronic system 500 can include, for example, a microphone input, touch-based display module (e.g., for interpreting gestures or commands received through user interaction with a display device, and/or one or more alphanumeric keyboards or pointing devices (also called “cursor control devices”).

Finally, as shown in FIG. 5, bus 508 also couples electronic system 500 to a network (not shown) through network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A computer-implemented method for providing user notifications, the method comprising:
receiving, at a mobile electronic device, an interest signal for a user associated with the mobile electronic device, the interest signal comprising a selection of one or more media items for which the user has indicated an interest;
receiving, at the mobile electronic device, a locations signal, the locations signal comprising location information corresponding with one or more of the user's preferred theatre locations; and
searching, by the mobile electronic device, a media database to determine if any of the one or more media items is available to the user, wherein searching the media database is performed using the interest signal and the locations signal.

2. The method of claim 1, further comprising:
identifying one or more media items in the media database based on the interest signal and the locations signal;
retrieving the one or more identified items from the media database, and
providing a notification to the user regarding the one or more identified items.

3. The method of claim 2, wherein the notification comprises information regarding the availability of the one or more identified items at the one or more of the user's preferred theatre locations.

4. The method of claim 2, wherein the notification comprises information regarding the availability of the one or more identified items during a first predetermined time window.

5. The method of claim 2, wherein the notification is provided to the user during a second predetermined time window.

6. The method of claim 2, further comprising:
determining, using the mobile electronic device, a current location of the user, and
wherein the notification is based on the current location of the user.

7. The method of claim 2, wherein the notification includes information facilitating a purchase of movie tickets associated with the one or more identified items.

8. A mobile computing device, comprising:
a display;
one or more processors communicatively coupled to the display; and
a computer-readable medium comprising instructions stored therein, which when executed by the processors, cause the processors to perform operations comprising:
receiving, at a mobile electronic device, an interest signal for a user associated with the mobile electronic device, the interest signal comprising a selection of one or more media items for which the user has indicated an interest;
receiving, at the mobile electronic device, a locations signal, the locations signal comprising location information corresponding with one or more of the user's preferred theatre locations; and
searching, by the mobile electronic device, a media database to determine if any of the one or more media items is available to the user, wherein searching the media database is performed using the interest signal and the locations signal.

9. The mobile computing device of claim 8, wherein the processors are further configured to perform operations comprising:
identifying one or more media items in the media database based on the interest signal and the locations signal;
retrieving the one or more identified items from the media database, and
providing a notification to the user regarding the one or more identified items.

10. The mobile computing device of claim 9, wherein the notification comprises information regarding the availability of the one or more identified items at the one or more of the user's preferred theatre locations.

11. The mobile computing device of claim 9, wherein the notification comprises information regarding the availability of the one or more identified items during a first predetermined time window.

12. The mobile computing device of claim 9, wherein the notification is provided to the user during a second predetermined time window.

13. The mobile computing device of claim 9, wherein the processors are further configured to perform operations comprising:
determining, using the mobile electronic device, a current location of the user, and
wherein the notification is based on the current location of the user.

14. The mobile computing device of claim 9, wherein the notification includes information for facilitating a purchase of movie tickets associated with the one or more identified items.

15. A computer-readable storage medium comprising instructions stored therein, which when executed by one or more processors, cause the processors to perform operations comprising:
receiving, at a mobile electronic device, an interest signal for a user associated with the mobile electronic device, the interest signal comprising a selection of one or more media items for which the user has indicated an interest;
receiving, at the mobile electronic device, a locations signal, the locations signal comprising location information corresponding with one or more of the user's preferred theatre locations; and
searching, by the mobile electronic device, a media database to determine if any of the one or more media items is available to the user, wherein searching the media database is performed using the interest signal and the locations signal.

16. The computer-readable storage medium of claim 15, wherein the processors are further configured to perform operations comprising:
identifying one or more media items in the media database based on the interest signal and the locations signal;
retrieving the one or more identified items from the media database, and
providing a notification to the user regarding the one or more identified items.

17. The computer-readable storage medium of claim 16, wherein the notification comprises information regarding the availability of the one or more identified items at the one or more of the user's preferred theatre locations.

18. The computer-readable storage medium of claim 16, wherein the notification comprises information regarding the availability of the one or more identified items during a first predetermined time window.

19. The computer-readable storage medium of claim 16, wherein the notification is provided to the user during a second predetermined time window.

20. The computer-readable storage medium of claim 16, further comprising:
determining, using the mobile electronic device, a current location of the user, and
wherein the notification is based on the current location of the user.
